(19) United States
(12) Patent Application Publication
(10) Pub. No.: US 2009/0122267 A1
(43) Pub. Date: May 14, 2009

(54) PROJECTION OPTICAL SYSTEM

(75) Inventors: SHIH-CHIEH CHOU, Tu-Cheng (TW); YU-SHAN CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/964,779

(22) Filed: Dec. 27, 2007

(30) Foreign Application Priority Data
Nov. 14, 2007 (CN) 200710202536.1

(51) Int. Cl. G03B 21/14

(52) U.S. Cl. 353/38

(57) ABSTRACT

A projection optical system includes a grating configured for splitting a light input into red, green and blue lights for generating red, green and blue lights of mutually different colors, a liquid crystal panel positioned to receive light outputs from the grating and configured for superimposing spatial information on the light outputs and emitting the light outputs comprising spatial information. The above-described projection optical system improves image contrast, and is suitable for use in adverse thermal environments. The projection optical system utilizes coupling of the grating and the liquid crystal panel to the projecting lens to achieve good image quality, without requiring costly, high index, low birefringence glass.

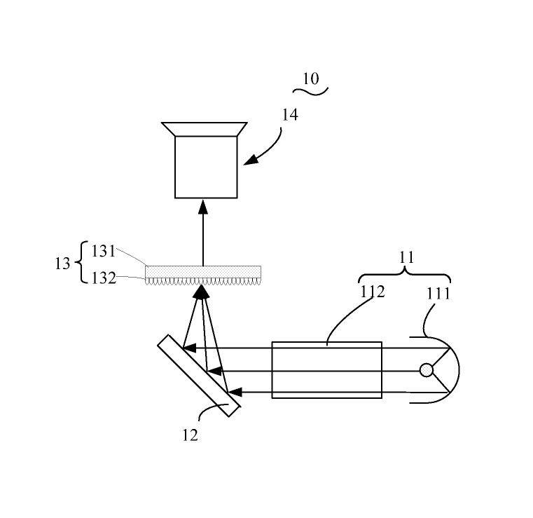

### RELATED FIELD

The present invention relates generally to projection optical systems, and more specifically to a projection optical system equipped with a grating.

### BACKGROUND

In conjunction with a projection display, it is necessary to employ an optical system. It is desirable that the optical system produces high contrast images and a relatively high level of illuminating flux. In general, current optical systems are capable of achieving increased contrast at practical levels of illuminating flux only by employing highly specialized materials. This makes the cost of such systems unattractive.

Many projection optical systems use solid “cube-type” polarizing beam-splitters for separation and recombination of incident light beams. These polarizing beam-splitters are otherwise referred to as MacNeille prisms or cube polarizing beam-splitters. “Cube type” polarizing beam-splitters are inherently susceptible to thermal gradients that typically arise at high flux levels. That is, at higher temperatures, stress birefringence often occurs in such beam-splitters. This results in depolarization of light and a loss of contrast. Thus, when high contrast images are desired, costly high-index, low-birefringence glass needs to be used. This solution has proven effective to reduce birefringence at low levels of flux. However the solution is expensive, and still has limited effectiveness in eliminating thermally induced birefringence at high flux levels.

It is desired to provide a projection optical system which can overcome the above-described deficiencies.

### SUMMARY

In accordance with an exemplary embodiment, a projection optical system includes a grating configured for splitting incident light input into red, green and blue emergent light output, a liquid crystal panel positioned to receive the light outputs from the grating and configured for superimposing spatial information on the light outputs and emitting the light outputs comprising spatial information.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

A drawing illustrates a configuration of a projection optical system according to an exemplary embodiment of the present invention.

### DETAILED DESCRIPTION OF THE PREFERRED EMBODIMENTS

A detailed explanation of a projection optical system according to an embodiment of the present invention will now be made with reference to the drawings attached hereto.

Referring to the drawing, a projection optical system includes a light source assembly 11, a grating 12 positioned to receive light output from the light source assembly 11, a liquid crystal panel 13 positioned to receive light emerging from the grating 12, and a projecting lens 14.

The light source assembly 11 includes a light source 111, and an integrator 112 positioned to receive the light emerging from the light source 111. The light source 111 can be a halogen lamp, a metal halogen lamp, a light emitting diode (LED), and the like. In the present embodiment, the light source 111 is a halogen lamp that emits white light. The integrator 112 is configured for processing the light beam emitted from the light source such that light beams exiting the integrator 112 have a uniform spatial distribution.

The grating 12 is an optical component with a surface covered by a regular pattern of etched parallel lines, typically with a distance between the lines comparable to the wavelength of light. The grating 12 can be a diffractive grating or a reflective grating. In the present embodiment, the grating 12 is a reflective grating, which is configured for splitting a light input from the light source assembly 11 into red, green, and blue lights and reflecting the red, green and blue lights to the liquid crystal panel 13.

The liquid crystal panel 13 includes a liquid crystal display 131 and a micro-lens array 132 disposed in an incident light side of the liquid crystal display 131. The liquid crystal display 131 is configured for superimposing spatial information on the red, green and blue lights and controlling contents of each of the red, green and blue lights to form a single light output having spatial information. The micro-lens array 132 is configured for condensing the light output from the grating 12 to promote the brightness of the light output from the liquid crystal panel 13.

The projecting lens 14 is positioned to receive light from the liquid crystal panel 13 and configured for magnifying the light and projecting an image on a screen (not shown).

The above-described projection optical system improves image contrast, and is suitable for use in adverse thermal environments. The projection optical system utilizes coupling of the grating 12 and the liquid crystal panel 13 to the projecting lens 14 to achieve good image quality, without requiring costly, high index, low birefringence glass.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A projection optical system, comprising:
a grating configured for splitting incident light input into red, green and blue emergent light output; and
a liquid crystal panel positioned to receive the light outputs from the grating and configured for superimposing spatial information on the light outputs and emitting the light outputs comprising spatial information.

2. The projection optical system as claimed in claim 1, wherein the liquid crystal panel comprising a micro-lens array and a liquid crystal display, the micro-lens array positioned in an incident light side of the liquid crystal display.

3. The projection optical system as claimed in claim 1, further comprising a light source assembly positioned to provide a light output for the grating.

4. The projection optical system as claimed in claim 1, wherein the grating is a diffractive grating.

5. The projection optical system as claimed in claim 1, wherein the grating is a reflective grating.

6. The projection optical system as claimed in claim 1, further comprising a projecting lens positioned to receive light output from the liquid crystal panel and configured for projecting an image.

7. A projection optical system, comprising:
a light source for emitting light therefrom;
a reflective grating configured for splitting the light emitted from the light source into red, green and blue emergent light output; and
a liquid crystal panel positioned to receive the light outputs from the reflective grating and configured for superimposing spatial information on the light outputs and emitting the light outputs comprising spatial information.
